(19) United States
(12) Patent Application Publication
(10) Pub. No.: US 2011/0228170 A1
(43) Pub. Date: Sep. 22, 2011

(54) Video Summary System

(75) Inventors: Yusuf Sinan Akgul, Gebze (TR); Ulas Vural, Gebze (TR); Alparslan Omer Yildiz, Gebze (TR)

(73) Assignee: Gebze Yuksek Teknoloji Enstitusu, Gebze (TR)

(21) Appl. No.: 12/728,172

(22) Filed: Mar. 19, 2010

(51) Int. Cl. H04N 5/14

(52) U.S. Cl. 348/700; 348/E05.062

(57) ABSTRACT

The invention video summary system (1) essentially comprises at least one imaging apparatus (2) which images the scene desired to be controlled, at least one display (3) which displays the outputs of the imaging apparatus (2), at least one monitor (4) which monitors the operators' eye-gaze position, at least one processor (5) which processes the outputs of the imaging apparatus and the monitoring system in order to determine the operator's awareness of the scene.

### TECHNICAL FIELD

The present invention relates to a method and apparatus for producing summaries of videos in coordination with an eye gaze monitor system.

### BACKGROUND ART

Security camera systems are often used in the facilities which require enhanced security. Security cameras can transport the scene being seen by the cameras to any viewing medium such as a monitor. The outputs of the security cameras can also be recorded in any storage media in order to be reviewed later and/or to be archived. Some integrated security camera systems can also give out a warning in case of any movement in their coverage area. But the success of any security camera system lies in the ability to react to different situations. In order to provide this, security officers monitor the outputs of the security systems.

No matter how vigilant a security officer is, there is always a chance that he misses a scene happening. This for sure renders the whole security system ineffective. Need for a system that detects if the security officer is aware of the situation or not is obvious. Furthermore the effectiveness of the security system depends on making the security officer aware of the situation that he missed.

A method and apparatus for generating a summary of a plurality of distinct data streams (for example video data streams) which collects plurality of related data streams and generates a video summary is mentioned in the United States patent document US2010017716.

### SUMMARY OF THE INVENTION

The objective of the present invention is to achieve a cheap, effective and simple video summary system.

Another objective of the present invention is to increase effectiveness of security monitoring systems using video summary system.

These and other embodiments of the present invention are further made apparent, in the remainder of the present document, to those of ordinary skill in the art.

### BRIEF DESCRIPTION OF THE DRAWINGS

The video summary system realized in order to fulfill the objectives of the—present—invention is illustrated in the attached figures, where:

FIG. 1—is the block diagram of the video summary system

FIG. 2—is the flowchart for the video summary method.

### DETAILED DESCRIPTION OF SPECIFIC EMBODIMENTS

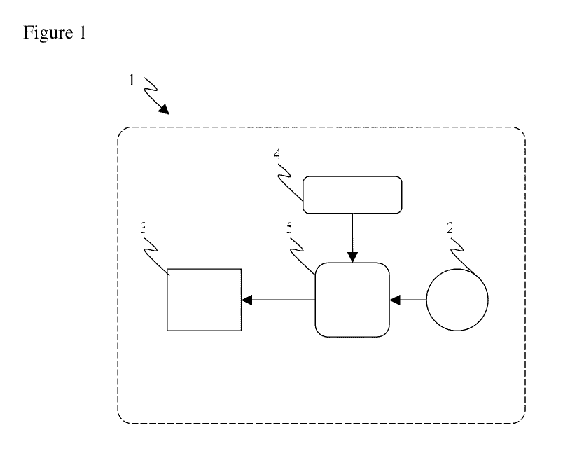

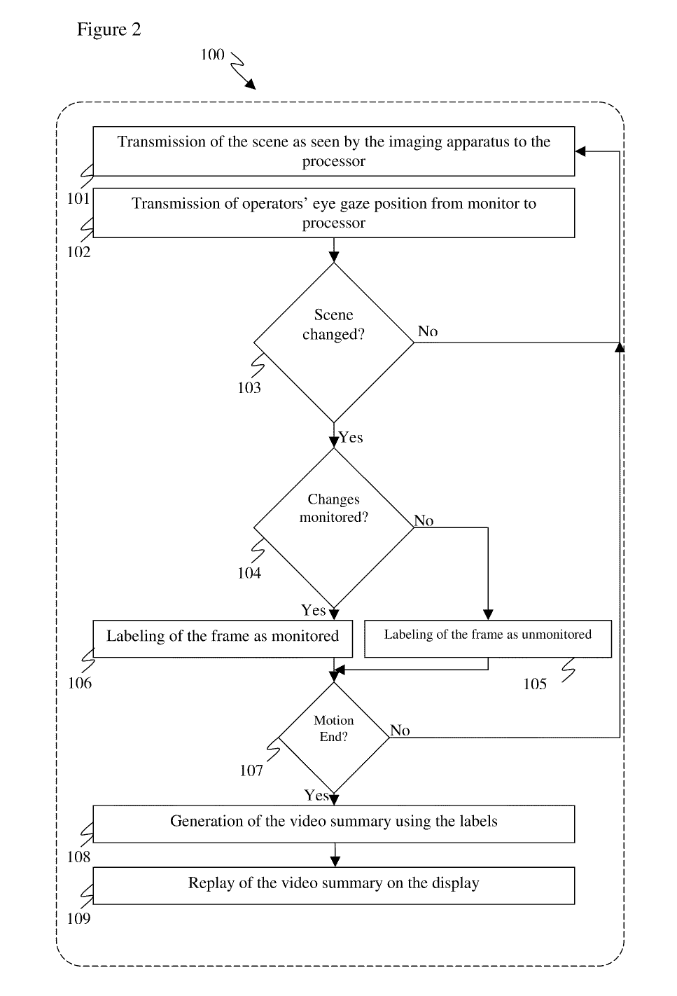

Elements shown in the FIGS. 1 and 2 are numbered as follows:
1. Video summary system
2. Imaging apparatus
3. Display
4. Monitor
5. Processor

The invention video summary system (1) essentially comprises at least one imaging apparatus (2) which images the scene desired to be controlled, at least one display (3) which displays the outputs of the imaging apparatus (2), at least one monitor (4) which monitors the operators' eye-gaze position, at least one processor (5) which processes the outputs of the imaging apparatus (2) and the monitor (4) in order to determine the operator's awareness of the scene.

Imaging apparatus (2) is the part that receives audio-visual feedback from a scene to be monitored. Imaging apparatus (2) can be a camera, night vision device, cctv node etc.

Display (3) is the part which outputs the data acquired from the imaging apparatus (2) to the operator. Display (3) can be any viewing device including but not limited to a CRT (cathode ray tube), LCD (Liquid Crystal Display), LED (Light emitting diode), OLED (organic LED) screen.

Monitor (4) is used to determine the eye-gaze position of the operator. Monitor (4) can be any eye-gaze position determination system including but not limited to active infrared based and visible image based eye-tracking systems.

Processor (5) is the part which receives inputs from the imaging apparatus (2) and the monitor (4) in order to determine if the operator is looking at the image received by the imaging apparatus and displayed on the display (3). In order to do so, processor (5) processes the image received from the imaging apparatus (2) and determines if there is any activity in the scene. Processor (5) also receives data from the monitor (4) and determines where the operator is looking at. Processor (5) then crosschecks the data and determines if the operator is looking at the portion of the display (3) where the activity is displayed or not.

Video summary method (100) comprises of

Transmission of the scene as seen by the imaging apparatus (2) to the processor (101),

Transmission of operators' eye gaze position from monitor (4) to processor (5) (102),

Determination of the changes in the scene (103),

If the scene has not changed return to 101,

If the scene has changed determination of the changes in the frame is monitored or not (104),

If the frame is not monitored labeling of the frame as unmonitored (105),

If the frame is monitored labeling of the frame as monitored (106),

Determination if the activity has stopped or not (107),

If the activity is still going on return to 101,

If the activity has stopped generation of the video summary using the labels (108),

Replay of the video summary on the display (3) (109) steps.

The imaging apparatus (2) transmits the image of the scene to the processor (5) (101). Transmission medium can be any communication means. Monitor (4) receives the eye gaze position of the operator and transmits it to the processor (5) (102) Transmission medium can be any communication means.

Processor (5) determines if the scene that the imaging apparatus (2) transmits is changed or not (103).

If the scene is changed, processor (5) crosschecks the data received from the monitor (4) and the imaging apparatus (2) in order to determine if the changes are monitored by the operator or not (104).

If the frame is monitored, that is if the operator is looking at the portion of display (3) where the changes are displayed, processor (5) labels the frame as monitored (105).

If the frame is not monitored, processor (5) labels the frame as unmonitored (106).

Processor (5) determines if the activity is still going on or not (107).

If the activity is still going on processor (5) resumes the method with step 101.

If the activity has stopped, processor (5) generates a video summary using the monitored or unmonitored frames which are labeled so (108).

Processor (5) transmits the generated video summary to the display (3) (109)

In the preferred embodiment of the invention, determination of the changes in the scene (103) is achieved as following:

Processor (5) determines the background and compares each frame with background. So a relative value of the difference between the background and the frame to a threshold value is achieved. If the difference between the frame and the background is greater than a threshold then the scene has changed (is changing). If the difference between the frame and the background is smaller than a threshold then the scene has not changed.

After determination of the changes in the scene, processor (5) needs to decide if the change is monitored by the operator or not. In the preferred embodiment of the invention, processor (5) keeps the track of changes in the scene in a corresponding array. The processor keeps the track of operator's eye-gaze positions in another array. In order to define if the operator is looking at the changes or not, processor (5) crosschecks these two arrays. If the position of change in the scene is within operator's eye-gaze position then the change is monitored and labeled so. If the position of change in the scene is outside of operator's eye-gaze position then the change is unmonitored and labeled so.

If the eye-gaze position of the operator is on the display area, we need a mechanism that shows of what sections of the video the operator is focused on. Although sensing and tracking actions generally can be done fast, operators cannot focus to see all the actions on a monitor if there are several independently moving objects. Detecting such a situation is also important to understand if the action is seen by operator or not. Human visual system has a good and efficient mechanism for tracking moving objects. The eye focuses near the moving object if there is only one object. It focuses at the center of moving objects if there are more than one related objects. A circular area around the eye-gaze position is assumed as the visual field where a human can catch actions.

In the preferred embodiment of the invention video summarization method (100) stacks the differences between successive images from the video to form a three dimensional (3D) volume of image pixels. This 3D volume is projected to a 2D image by summing the vertical columns. An energy image is computed from the projection image such that pixels with more action information have higher energy values. This energy image is modified by using the eye gaze positions of the operator. The pixels would have more energy if they correspond to operator eye gaze positions. A vertical path with small cumulative energy values can be removed from the projection image without losing any observed or unobserved actions. This path can be discarded without losing significant image information because it includes only pixels without any action information. Applying this method several times results in shrinking the image while preserving the pixels with information. The method then removes the columns from video that correspond the minimum energy paths. This process is called fast non-linear video synopsis. Non-linear video synopsis approach lets objects move on the time axis independently to compress the activity from different time intervals into a very small time volume. Furthermore, chronology of a single pixel value is allowed to change, meaning that events of different time steps for the same region of the video image can be collated in any order. In the final summarized video, a single frame is most likely composed of activity from different frames of the original video.

In another embodiment of the invention, video summarization method (100) can use linear summarization techniques by eliminating complete video frames that do not contain any action information. Frames that contain action information but not observed by the operator can also be used in the video summarization.

In another embodiment of the invention, video summarization method (100) can use the monitored or unmonitored frames from different scenes in order to generate non-linear video summaries. By this video summarization method (100) generates denser summaries which are size effective to store and less time consuming to watch.

Although the present invention has been described and illustrated in detail, it is clearly understood that the same is by way of illustration and example only and is not to be taken by way of limitation. Those of ordinary skill in the art would be able to practice such other embodiments without undue experimentation. The spirit and scope of the present invention, is not limited merely to the specific example embodiments or alternatives of the foregoing description.

We claim:

1. A method of video summary, the method comprising the steps of:
transmission of the scene as seen by the imaging apparatus (2) to the processor (101), transmission of operators' eye gaze position from monitor (4) to processor (5) (102), determination of the changes in the scene (103), if the scene has not changed returning to step 101, if the scene has changed determination of the changes in the frame is monitored or not (104), if the frame is not monitored labeling of the frame as unmonitored (105), if the frame is monitored labeling of the frame as monitored (106), determination if the activity has stopped or not (107), if the activity is still going on returning to step 101, if the activity has stopped generation of the video summary using the labels (108), replay of the video summary on the display (3) (109).

2. A method according to claim 1, wherein the method further comprises the step of determining the background and comparing each frame with background.

3. A method according to any of the above claims, wherein the method further comprises the step of determining the scene has changed using the relative value of difference between the frame and the background to a threshold value.

4. A method according to any of the above claims, wherein the method further comprises the step of using the monitored frames from different scenes in order to generate video summaries

5. A method according to any of the above claims, wherein the method further comprises the step of using the unmonitored frames from different scenes in order to generate video summaries

6. A method according to any of the above claims, wherein the method further comprises the step of using the monitored frames from different scenes in order to generate non-linear video summaries.

7. A method according to any of the above claims, wherein the method further comprises the step of using the unmonitored frames from different scenes in order to generate non-linear video summaries

8. A video summary system (1) according to claims 1-7 comprising at least one imaging apparatus (2) which images the scene desired to be controlled, at least one display (3) which displays the outputs of the imaging apparatus (2), at least one monitor (4) which monitors the operators' eye-gaze position, at least one processor (5) which processes the outputs of the imaging apparatus and the monitoring system in order to determine the operator's awareness of the scene.
